(19) United States
(12) Patent Application Publication
(10) Pub. No.: US 2026/0124114 A1
(43) Pub. Date: May 7, 2026

(54) PORTABLE INSULIN COOLER CASE

(71) Applicant: Moshe Lewartowski, New Square, NY (US)

(72) Inventor: Moshe Lewartowski, New Square, NY (US)

(21) Appl. No.: 19/381,165

(22) Filed: Nov. 6, 2025

Related U.S. Application Data
(60) Provisional application No. 63/717,165, filed on Nov. 6, 2024.

(51) Int. Cl. A61J 1/16

(52) U.S. Cl. CPC A61J 1/165; A61J 2200/44; A61J 2200/50; A61J 2200/72

(57) ABSTRACT

A portable insulin cooler case includes a front cover and rear cover connected by a hinge forming an enclosure, and a closure mechanism positioned around perimeter edges providing secure sealing capabilities. The portable insulin cooler case includes a housing positioned on the front cover containing a display screen configured to display temperature information. The housing encompasses three buttons functioning as ON/OFF control, alarm control, and High/Low temperature recording control respectively. The portable insulin cooler case includes a first indented section formed within the front cover configured to receive a cooling device, and a thermometer positioned within the first indented section configured to monitor internal temperature. The first indented section includes elastic bands configured to secure insulin injection pens or insulin containers. The portable insulin cooler case includes a pocket formed between the front cover and rear cover configured to store diabetic accessories.

### CROSS-REFERENCE TO RELATED APPLICATIONS

The present application claims priority to a Provisional Application No. 63/717,165, filed Nov. 6, 2024 which is hereby incorporated by reference in its entirety.

### BACKGROUND OF THE INVENTION

### Field of the Invention

The present disclosure relates to portable temperature-controlled storage devices for temperature-sensitive medications, and more particularly to a portable insulin cooler case with integrated temperature monitoring, alarm functionality, and digital display capabilities for maintaining insulin within safe temperature ranges during transport and storage.

### Description of the Prior Art

Diabetes affects millions of individuals worldwide, with approximately 37.3 million people in the United States living with diabetes, representing over 11% of the population. Of these individuals, approximately 1.9 million have Type 1 diabetes and require daily insulin injections to manage their blood glucose levels and maintain life-sustaining metabolic function. A typical insulin-dependent diabetic may require multiple injections throughout the day, including a morning injection before leaving home and additional injections during work hours or while traveling. Insulin is a highly temperature-sensitive biological medication that maintains its therapeutic effectiveness only within a narrow temperature range, typically between 36° F. and 46° F. (2° C. to 8° C.) when unopened, and exposure to temperatures outside this critical range can cause irreversible degradation of the insulin's molecular structure, rendering it ineffective or potentially harmful to users.

The biochemical stability of insulin is critically dependent on maintaining proper storage temperatures throughout its lifecycle. Unopened insulin vials and cartridges must be stored continuously between 36° F. and 46° F. (2° C. to 8° C.) to preserve their potency and prevent protein denaturation. When insulin is exposed to temperatures above 86° F. (30° C.) or below freezing at 32° F. (0° C.), the protein structure begins to break down irreversibly, causing clumping, precipitation, or loss of biological activity. Once opened, insulin can be stored at room temperature between 59° F. and 86° F. (15° C. to 30° C.) for a limited period of 28 to 42 days depending on the specific insulin formulation, but even during this room-temperature storage period, exposure to temperature extremes can rapidly degrade the medication's effectiveness. The challenge becomes particularly acute during transportation, where insulin may be subjected to varying environmental conditions, temperature fluctuations, and extended periods without refrigeration.

The mobility requirements of insulin-dependent diabetics have created a critical need for portable, reliable cooling systems that can maintain proper insulin storage temperatures during travel, work, and daily activities away from home refrigeration. Diabetic individuals must maintain continuous access to properly stored insulin regardless of their location, whether traveling for business, vacation, outdoor activities, or simply during extended periods away from home during normal daily routines. This requirement becomes particularly challenging in situations where traditional refrigeration is unavailable, unreliable, or impractical, such as during air travel, camping, hiking, international travel to remote locations, or extended work assignments. The consequences of insulin degradation due to improper temperature storage can be severe, potentially leading to inadequate blood glucose control, diabetic ketoacidosis, or other life-threatening complications.

Travel presents particularly complex challenges for insulin storage and temperature management. During air travel, insulin may be exposed to extreme temperatures in cargo holds, security screening processes, and varying airport environments. Ground transportation exposes insulin to vehicle interior temperatures that can exceed safe storage limits, particularly during summer months when car interiors can reach temperatures above 120° F. (49° C.). Hotel accommodations may have unreliable mini-refrigerators or inadequate temperature control, and remote destinations such as camping sites, hunting lodges, fishing cabins, or international locations may lack any refrigeration infrastructure. Even with careful advance planning, diabetic travelers face ongoing uncertainty about maintaining proper insulin storage conditions throughout their journey, creating stress and potential health risks that can significantly impact their quality of life and willingness to travel.

Traditional approaches to portable insulin cooling have relied primarily on insulated containers packed with conventional ice, dry ice, or gel-based cooling packs. While these passive cooling methods can maintain proper temperatures for 8-24 hours, they lack integrated intelligence and feedback features, including no means of real-time temperature monitoring or user alerts to indicate potential temperature deviations. They also often have a bulky and heavy construction that makes them impractical for extended travel or daily carry and inconveniently require frequent replacement of cooling materials. Conventional ice-based systems also present risks of freezing the insulin if direct contact occurs, while dry ice systems pose safety hazards and are prohibited on commercial aircraft. Furthermore, these passive systems provide no feedback mechanism to verify that proper temperatures have been maintained, leaving users uncertain about their insulin's viability and potentially leading to unnecessary disposal of expensive medication or, conversely, use of degraded insulin with reduced therapeutic effectiveness. In contrast, the present invention enhances passive cooling technology by integrating intelligent monitoring, early warning, and flexible user alert systems that actively inform the user of temperature status without altering the passive cooling duration.

Several insulin storage and cooling systems have been disclosed in the prior art attempting to address these challenges. One such example is disclosed in a U.S. Pat. No. 5,865,032, entitled “Thermoelectric medicine cooling bag” (“the '032 Patent”). The '032 Patent discloses a personal manually portable thermoelectric-cooling medicine kit, particularly for insulin. The medicine in the kit is cooled by a Peltier heat pump. The vials of medicine inside the kit are tilted to maximize heat transfer efficiency when the kit is either upright or laid flat. A cap is provided to shield an insulin vial from UV radiation while the case is open and the person is preparing for an injection. The kit includes components which are Velcro-attached to the lining of the kit.

Another approach is disclosed in a U.S. Pat. No. 6,253,570, entitled “Traveling bag with exterior display of interior temperature” (“the '570 Patent”). The '570 Patent discloses a traveling bag for carrying temperature-sensitive medications such as insulin which includes a sensor monitoring the interior temperature and an exterior display showing the measured temperature. In one embodiment the bag interior includes a compartment for storing medication, an assembly for securely holding three insulin pens, and a compartment for holding a container of freezing material. A second embodiment of the bag omits the freezing material compartment.

Although the above discussed disclosures are useful, they still have problems and present incomplete solutions. For example, existing portable insulin cooling systems often lack comprehensive temperature monitoring capabilities that provide real-time feedback and historical temperature data logging, making it difficult for users to verify that their insulin has remained within safe temperature ranges throughout storage and transport periods. Furthermore, many current systems do not include integrated alarm functionality to alert users when temperature conditions become unsuitable for insulin storage, potentially allowing medication degradation to occur without the user's knowledge. Additionally, existing portable cooling devices typically lack user-friendly digital interfaces that clearly display temperature information and system status, often relying on basic analog displays or simple indicator lights that provide limited information about the cooling system's performance and the insulin's storage conditions. Furthermore, existing systems do not provide dynamic visual feedback that automatically alerts users to temperature changes through display activation. When users are engaged in medical procedures, professional activities, or other tasks requiring attention, static displays require active monitoring to detect temperature variations. A display that visibly flashes or illuminates upon each whole-degree temperature change would enable users to detect temperature fluctuations through peripheral vision without requiring constant direct observation of the device.

Therefore, there is a need in the art to provide a portable insulin cooling device that maintains the convenience and reliability of passive cooling methods while incorporating intelligent monitoring, real-time temperature feedback, and user alert capabilities. Such a system should feature a digital display that visibly flashes or illuminates upon each whole-degree temperature change, thereby enhancing user awareness of temperature fluctuations without requiring constant observation. This solution would address the limitations of conventional passive coolers by ensuring users are immediately informed of unsafe temperature conditions, improving confidence in insulin storage safety during daily use and travel.

### SUMMARY OF THE INVENTION

It is an object of the present invention to provide a portable insulin cooler case that maintains insulin within safe temperature ranges during transport and storage.

It is another object of the present invention to provide a portable insulin cooler case with integrated temperature monitoring capabilities that provide real-time feedback and historical temperature data logging.

It is another object of the present invention to provide a portable insulin cooler case with comprehensive alarm functionality that alerts users when temperature conditions become unsuitable for insulin storage.

It is another object of the present invention to provide a portable insulin cooler case with user-friendly digital display capabilities that clearly present temperature information and system status through color-coded visual indicators.

It is another object of the present invention to provide a portable insulin cooler case that operates as a compact, self-contained temperature-controlled storage solution with organized internal compartments for insulin injection pens, insulin containers, and diabetic accessories.

In order to achieve one or more objectives, the present invention provides a portable insulin cooler case having a front cover and a rear cover connected by a hinge to form an enclosure. The portable insulin cooler case includes a closure mechanism positioned around perimeter edges of the front cover and the rear cover to provide secure sealing capabilities. The portable insulin cooler case includes a housing positioned on the front cover containing a display screen configured to display temperature information and a first button, a second button, and a third button for user control functions. The portable insulin cooler case includes a first indented section formed within the front cover and configured to receive a cooling device, with a thermometer positioned within the first indented section to monitor internal temperature. The portable insulin cooler case includes elastic bands positioned within the first indented section and configured to secure insulin injection pens or insulin containers, and a pocket formed between the front cover and the rear cover configured to store diabetic accessories.

The display screen is configured to provide color-coded temperature indication, displaying Blue coloration for normal refrigeration temperature, Orange coloration when approaching temperature limits, and Red coloration when temperature limits are exceeded.

The portable insulin cooler case includes a holding sleeve positioned within the first indented section. The elastic bands are attached to a surface of the holding sleeve for securing insulin storage items.

The portable insulin cooler case includes dual cooling capacity through the first indented section in the front cover and a second indented section in the rear cover configured to accommodate additional cooling devices that supplement temperature control and extend cooling duration.

The portable insulin cooler case includes organized storage through the pocket comprising a first layer made of mesh material and a second layer made of fabric material configured to store diabetic accessories.

In one advantageous feature of the present invention, the portable insulin cooler case provides color-coded temperature indication through the display screen, displaying Blue coloration for normal refrigeration temperature, Orange coloration when approaching temperature limits, and Red coloration when temperature limits are exceeded.

In another advantageous feature of the present invention, the portable insulin cooler case operates with customizable alarm functionality through the second button that allows users to set temperature thresholds triggering audible or visual alarms when internal temperature rises above or falls below specified limits.

In yet another advantageous feature of the present invention, the portable insulin cooler case provides historical temperature recording capabilities through the third button that enables users to view highest and lowest temperatures reached during specified monitoring periods.

In yet another advantageous feature of the present invention, the portable insulin cooler case provides uniquely efficient storage organization through a space-optimized internal layout. The elastic band arrangement and pocket configuration enable the case to simultaneously accommodate four insulin injection pens while also storing all essential diabetes management items including: a glucose meter device, test strips in their original manufacturer's container, a lancing device, lancets, alcohol swabs or prep pads, and pen needles—all within a compact, portable form factor. This storage capacity and organization exceeds conventional portable insulin coolers, which typically cannot accommodate both multiple insulin pens and the full complement of diabetes management accessories simultaneously without increased bulk.

In yet another advantageous feature of the present invention, the portable insulin cooler case enables wireless communication through a transceiver that connects to mobile devices for temperature updates, alarm notifications, and historical temperature data access, while maintaining self-contained operation for portable insulin storage and monitoring.

It is another object of the present invention to provide a portable insulin cooler case with predictive temperature management capabilities that analyze environmental conditions and usage patterns to generate preemptive alerts before unsafe storage conditions occur.

It is another object of the present invention to provide a portable insulin cooler case with comprehensive environmental monitoring through integrated humidity and barometric pressure sensors that detect conditions likely to compromise insulin integrity through multiple degradation pathways.

It is another object of the present invention to provide a portable insulin cooler case with child lock functionality that prevents unauthorized modification of critical temperature monitoring parameters.

It is another object of the present invention to provide a portable insulin cooler case with tamper detection capabilities that document access events and maintain accountability for insulin storage integrity during shared custody or institutional use.

It is another object of the present invention to provide a portable insulin cooler case with supplementary power generation through solar or kinetic energy harvesting to extend operational capability during remote use.

It is another object of the present invention to provide a portable insulin cooler case with caregiver alert escalation that ensures critical temperature deviations receive timely attention even when primary users are unable to respond.

It is another object of the present invention to provide a portable insulin cooler case with integrated medication adherence support that prompts timely insulin administration and tracks compliance patterns for clinical review.

These and other objects of the present invention will be apparent from review of the following specification and the accompanying drawings.

### BRIEF DESCRIPTION OF THE DRAWINGS

FIG. 1A, FIG. 1B, FIG. 1C, and FIG. 1D illustrate a first perspective view, a second perspective view, a side view, and a rear view, respectively of a portable insulin cooler case, in accordance with one exemplary embodiment of the present invention.

FIG. 2 illustrates a perspective view of internal components of the portable insulin cooler case in an open configuration, in accordance with one embodiment of the present invention.

FIG. 3 illustrates a perspective view of the portable insulin cooler case of in an open configuration revealing internal storage arrangement, in accordance with one embodiment of the present invention.

FIG. 4A and FIG. 4B illustrate a bottom perspective view, and a front view, respectively, of a thermometer, in accordance with one embodiment of the present invention.

FIG. 5 illustrates a perspective view of internal components of the portable insulin cooler case displaying the rear cover, in accordance with one embodiment of the present invention.

FIG. 6 illustrates a block diagram of an insulin cooler showing internal electronic components, in accordance with one embodiment of the present invention.

### DETAILED DESCRIPTION OF THE PREFERRED EMBODIMENT

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed portable insulin cooler case. However, it will be apparent to those skilled in the art that the presently disclosed invention may be practiced without these specific details. In some instances, well-known structures and devices are shown in functional or conceptual diagram form in order to avoid obscuring the concepts of the presently disclosed portable insulin cooler case.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

It will be understood that, although the terms first, second, third, etc. may be used herein to describe various elements, components, regions, and/or sections, these elements, components, regions, and/or sections should not be limited by these terms. These terms are only used to distinguish one element, component, region, and/or section from another element, component, region, and/or section.

It will be understood that the elements, components, regions, and sections depicted in the figures are not necessarily drawn to scale.

Although the present invention provides a description of a portable insulin cooler case, it is to be further understood that numerous changes may arise in the details of the embodiments of the portable insulin cooler case. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

Various features and embodiments of a portable insulin cooler case are explained in conjunction with the description of FIGURES (FIGS.) 1-6.

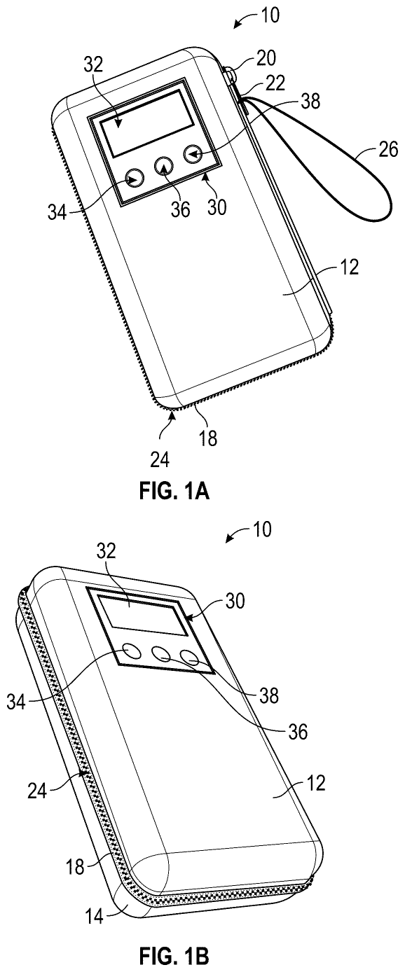

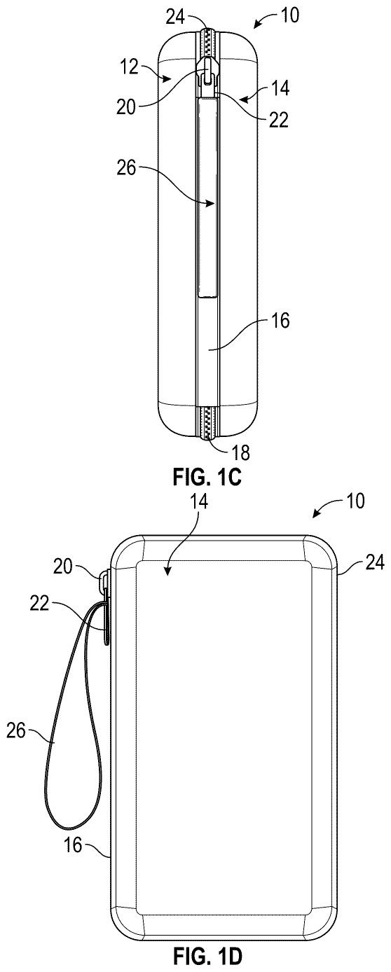

FIG. 1A, FIG. 1B, FIG. 1C, and FIG. 1D show a first perspective view, a second perspective view, a side view, and a rear view, respectively, of a portable insulin cooler case 10, in accordance with the present invention. Portable insulin cooler case 10 provides an overall structure configured for storing and transporting insulin while maintaining temperature control during extended periods away from traditional refrigeration. Portable insulin cooler case 10 includes a front cover 12 and a rear cover 14 that together form an enclosure. As used herein, the term “portable insulin cooler case” refers to a temperature-controlled storage device specifically designed to maintain insulin within safe temperature ranges of 36° F. to 46° F. (2° C. to 8° C.) for unopened insulin or 59° F. to 86° F. (15° C. to 30° C.) for opened insulin during transport and daily use.

Portable insulin cooler case 10 is constructed from hard or semi-hard materials, fabric, or leather type material, providing durability and protection for the contents stored within while maintaining thermal insulation properties necessary for temperature regulation. As used herein, the terms “portable insulin cooler case” and “portable insulin storage system” may be used interchangeably to refer to the same temperature-controlled storage device configured for maintaining insulin within safe temperature ranges during transport and storage applications.

Each of Front cover 12 and rear cover 14 is formed in a recessed cavity and when combined together create a substantially rectangular box-like configuration suitable for accommodating insulin storage requirements. The recessed cavity of front cover 12 and rear cover 14 provides internal volume for accommodating cooling devices, insulin storage components, and monitoring equipment while maintaining a compact external profile suitable for portable use during travel, work, and daily activities. Front cover 12 is fabricated from insulating materials that help maintain internal temperature stability and protect insulin from external temperature fluctuations. Rear cover 14 incorporates similar thermal insulation properties and is designed to complement the front cover 12 in creating a sealed environment for insulin storage.

With continued reference to FIG. 1C and FIG. 1D, front cover 12 and rear cover 14 are connected by a hinge 16. Hinge 16 includes a mechanical hinge, fabric, or any connecting material that holds front cover 12 and rear cover 14 together while allowing portable insulin cooler case 10 to open and close smoothly. Hinge 16 is constructed from durable materials that withstand repeated opening and closing cycles during daily use while maintaining the structural integrity of the portable insulin cooler case 10. Hinge 16 enables portable insulin cooler case 10 to transition between an open configuration for accessing internal components and insulin supplies and a closed configuration for secure transport and temperature maintenance.

In one embodiment, zipper teeth 18 and slider 20 are configured as a waterproof zipper assembly that provides enhanced protection against moisture ingress from rain, spills, or humid environments encountered during travel and daily use. The waterproof configuration of closure mechanism 24 ensures that external moisture does not penetrate the internal insulin storage environment, thereby protecting insulin supplies and electronic components from water damage while maintaining the thermal insulation properties of portable insulin cooler case 10.

As further shown in FIG. 1A, FIG. 1B, FIG. 1C, and FIG. 1D, portable insulin cooler case 10 includes a closure mechanism 24 positioned around the perimeter edges of front cover 12 and rear cover 14 to provide secure sealing capabilities. Closure mechanism 24 is strategically positioned to extend continuously along the entire perimeter boundary where front cover 12 and rear cover 14 meet, creating a complete encircling seal around the junction between the two covers. The positioning of closure mechanism 24 around the perimeter edges ensures that the sealing interface encompasses all potential air entry points along the cover junction, thereby maintaining thermal isolation of the internal insulin storage environment. Closure mechanism 24 encompasses zipper teeth 18, a slider 20, and a pull tab 22 that work together to secure portable insulin cooler case 10 in a closed position and maintain thermal insulation. Zipper teeth 18 run around the complete perimeter edge of both front cover 12 and rear cover 14, following the contour of the covers to provide a continuous sealing interface when portable insulin cooler case 10 is closed. The perimeter arrangement of zipper teeth 18 creates a closed-loop sealing configuration that encircles the entire junction between front cover 12 and rear cover 14, with individual zipper teeth 18 positioned at regular intervals along the perimeter to ensure consistent engagement and sealing performance. Zipper teeth 18 are designed to create an airtight or substantially airtight seal that prevents external air circulation from affecting the internal temperature environment where insulin is stored. Slider 20 engages with zipper teeth 18 and is manipulated via pull tab 22 to open or close portable insulin cooler case 10 for accessing insulin supplies or monitoring internal conditions. Slider 20 travels along the perimeter path defined by zipper teeth 18 to progressively connect or disconnect front cover 12 and rear cover 14 around the entire perimeter, thereby controlling access to the internal compartment of the portable insulin cooler case 10 while maintaining the integrity of the perimeter seal. Pull tab 22 is sized and shaped to provide comfortable grip and manipulation by users, including those who have dexterity limitations associated with diabetes-related complications.

Further, portable insulin cooler case 10 includes a lanyard 26. Lanyard 26 is attached to portable insulin cooler case 10 in proximity to hinge 16 to provide convenient carrying and security options for the users. Lanyard 26 provides a means for carrying or securing the portable insulin cooler case 10, allowing the users to transport the device conveniently while maintaining access to the insulin storage and monitoring functions during daily activities. Lanyard 26 is constructed from durable materials such as nylon webbing or fabric that can withstand regular use and environmental exposure. Lanyard 26 is adjustable in length to accommodate different carrying preferences and includes attachment points (not shown) that allow the users to secure portable insulin cooler case 10 to bags, belts, or other carrying equipment to prevent loss or accidental separation from essential insulin supplies.

Still referring to FIG. 1A and FIG. 1B, portable insulin cooler case 10 includes a housing 30 positioned on front cover 12. Housing 30 is strategically positioned on the exterior surface of front cover 12 to provide convenient user access to electronic controls while maintaining protection for internal components. Housing 30 is configured to contain electronic components and user interface elements that enable temperature monitoring and control functions for portable insulin cooler case 10. Housing 30 is constructed from durable materials that protect internal electronic components from environmental exposure while providing accessible user interface controls. Housing 30 is securely integrated into the structure of front cover 12 through a recessed mounting configuration that positions housing 30 flush with or slightly raised from the surface of front cover 12. The integration of housing 30 with front cover 12 may be achieved through mechanical fasteners, adhesive bonding, ultrasonic welding, or molded-in-place attachment methods that create a permanent, weatherproof connection between housing 30 and front cover 12. Housing 30 includes sealed interfaces around display screen 32 and button controls to prevent moisture ingress while maintaining tactile feedback for user operation. The positioning of housing 30 on front cover 12 ensures that display screen 32 and control buttons remain visible and accessible when portable insulin cooler case 10 is in use, while the structural integration provides mechanical stability during transport and daily handling.

Housing 30 integrates with front cover 12 through a snap-fit mounting mechanism that provides secure attachment while enabling removal for battery replacement or maintenance. Housing 30 incorporates a protruding cover section that extends approximately 4 millimeters above the surface of front cover 12, creating a low-profile mounting arrangement that maintains the streamlined appearance of portable insulin cooler case 10. A flexible tooth or snap feature is molded into the bottom surface of housing 30, configured to engage with a corresponding aperture formed in front cover 12. During installation, the flexible tooth deflects as housing 30 is pressed into position, then returns to its original configuration when the tooth aligns with the aperture, creating an audible and tactile click that confirms secure mounting. This snap-fit configuration allows housing 30 to be securely retained within front cover 12 with only the display surface of housing 30 visible from the exterior, while the structural integration provides mechanical stability during transport and daily handling.

Housing 30 encompasses a display screen 32 configured to provide visual feedback regarding the temperature status of portable insulin cooler case 10. Display screen 32 is positioned within housing 30 to be visible to the users when portable insulin cooler case 10 is in use. Display screen 32 displays temperature information in either degrees Fahrenheit or degrees Celsius, allowing the users to monitor the internal temperature conditions where insulin is stored. Display screen 32 may include digital display technology such as liquid crystal display (LCD), light-emitting diode (LED), or organic light-emitting diode (OLED) displays that provide clear visibility under various lighting conditions encountered during daily use and travel.

In one implementation, display screen 32 provides color-coded indication to communicate the status of the internal temperature of portable insulin cooler case 10. Display screen 32 displays Blue coloration to indicate that the internal temperature of portable insulin cooler case 10 is within normal refrigeration temperature ranges suitable for insulin storage. Display screen 32 displays Orange coloration to indicate that the internal temperature is approaching the limits of the required refrigeration temperature, providing an early warning to users that corrective action may be needed. Display screen 32 displays Red coloration to indicate that the internal temperature has reached and/or exceeds the recommended refrigeration temperature, alerting users that insulin stored within portable insulin cooler case 10 may be at risk of temperature-related degradation.

While the exemplary embodiment describes Blue, Orange, and Red coloration for temperature status indication, alternative embodiments may implement other color combinations that provide clear visual distinction between safe, warning, and danger temperature zones. For example, alternative embodiments may utilize Green, Yellow, and Red coloration, or other three-color progressions wherein each color provides visually distinct indication that enables users to quickly assess temperature status through color recognition. The color-coded indication system should utilize colors that are readily distinguishable under various lighting conditions and provide intuitive progression from safe to warning to danger status.

In one advanced embodiment, portable insulin cooler case 10 may incorporate predictive temperature management capabilities through an environmental analysis algorithm executed by microcontroller 104. The predictive system analyzes historical temperature data stored in memory module 106, current temperature trends measured by thermometer 52, and user behavior patterns to forecast when internal temperature conditions may approach unsafe storage parameters. The predictive algorithm processes multiple input variables including rate of temperature change, time elapsed since last cooling device replacement, ambient environmental conditions, and historical cooling performance data to generate probabilistic predictions of when cooling capacity may be exhausted or environmental conditions may exceed the thermal management capabilities of cooling device 42. When the predictive analysis determines that temperature excursions are likely within a specified time horizon, microcontroller 104 generates preemptive alerts displayed on display screen 32 and transmitted via transceiver 126 to connected mobile devices, advising users to replace cooling device 42, relocate portable insulin cooler case 10 to a cooler environment, or take other preventive measures before actual temperature deviations occur. The preemptive warning system may incorporate machine learning algorithms that improve prediction accuracy over time by analyzing the relationship between predicted temperature excursions and actual temperature outcomes, adjusting prediction parameters stored in memory module 106 to enhance forecast reliability for specific usage patterns and environmental conditions. This predictive approach provides users with advance notice of potential temperature management issues, enabling proactive intervention that prevents insulin exposure to unsafe storage conditions rather than merely reacting to temperature deviations after they occur.

In another embodiment, portable insulin cooler case 10 may include an environmental monitoring module comprising a humidity sensor and a barometric pressure sensor integrated with processing unit 102 to provide comprehensive environmental condition assessment beyond temperature monitoring alone. The humidity sensor measures relative humidity within the internal storage area of portable insulin cooler case 10, detecting moisture levels that may indicate condensation formation, seal degradation, or environmental conditions that could promote bacterial growth or affect insulin stability through mechanisms independent of temperature exposure. The barometric pressure sensor monitors atmospheric pressure conditions that may correlate with altitude changes during air travel, weather system transitions, or environmental factors that influence the thermal performance of cooling device 42 and the rate of temperature change within portable insulin cooler case 10. Microcontroller 104 processes humidity and barometric pressure data in conjunction with temperature measurements from thermometer 52 to generate composite environmental assessments that identify conditions likely to cause insulin degradation through multiple simultaneous stress factors. When humidity levels exceed predetermined thresholds that indicate condensation risk or moisture-related degradation potential, or when barometric pressure readings indicate altitude or weather conditions associated with accelerated temperature change, microcontroller 104 generates environmental warning alerts displayed on display screen 32 and transmitted via transceiver 126 to inform users of conditions that may compromise insulin storage integrity through pathways beyond simple temperature excursion. The environmental monitoring module may store historical humidity and pressure data in memory module 106, enabling trend analysis that identifies patterns of environmental exposure and provides users with insights into how storage conditions vary across different usage scenarios, travel routes, or seasonal conditions.

Housing 30 further encompasses a plurality of control buttons such as a first button 34, a second button 36, and a third button 38 that provide user control functions for portable insulin cooler case 10. First button 34 functions as an ON/OFF control implemented as a touch-sensitive switch that enables users to power the electronic components of portable insulin cooler case 10 on or off as needed. First button 34 may be configured as a momentary switch or toggle switch that controls electrical power distribution to display screen 32 and associated monitoring components. Brief contact of first button 34 turns display screen 32 on, while maintaining contact with first button 34 for 3 seconds powers the entire portable insulin cooler case 10 on or off. During alarm setting mode, activation of first button 34 functions to decrease the temperature threshold setting. Second button 36 serves as an alarm control that enables the users to set and configure temperature alert functions. Second button 36 allows the users to establish temperature thresholds that trigger audible or visual alarms when the internal temperature of portable insulin cooler case 10 rises above or falls below specified temperature limits set by the user. A short touching of second button 36 changes the alarm temperature setting, while maintaining contact with second button 36 for 3 seconds turns the alarm sound on or off.

Second button 36 serves as an alarm control implemented as a touch-sensitive switch that enables users to customize alarm threshold temperatures based on individual preferences, anxiety levels, or specific usage scenarios. A brief touch of second button 36 changes the alarm temperature setting, while maintaining contact with second button 36 for 3 seconds turns the alarm sound on or off. Unlike fixed-threshold alarm systems, the user-customizable alarm functionality allows each user to set their preferred warning temperature, accommodating users who desire earlier alerts even before dangerous temperature conditions are approached. This customization capability addresses the varying comfort levels and risk tolerance among insulin-dependent users, providing personalized temperature monitoring that adapts to individual needs. For example, a user traveling to a hot climate may set a lower alarm threshold to receive earlier warning of temperature increases, while a user in a controlled indoor environment may set a higher threshold to reduce unnecessary alerts.

As further shown in FIG. 1B, third button 38 operates as a High/Low temperature recording control implemented as a touch sensitive switch that provides access to temperature history data collected during monitoring cycles. Third button 38 allows the users to view the highest temperature and lowest temperature reached inside portable insulin cooler case 10 during a specified recording period. A brief touch of third button 38 displays the highest temperature in red coloration followed by the lowest temperature in blue coloration throughout the recorded cycle. Touching third button 38 again during the temperature display allows the users to switch between degrees Fahrenheit (°F.) and degrees Celsius (°C.) temperature units. Maintaining contact with third button 38 for 3 seconds resets the high/low tracking cycle, initiating a new recording period for tracking temperature variations over different time periods. This functionality provides valuable data for assessing the thermal performance of portable insulin cooler case 10 under various environmental conditions. The High and Low temperature data recorded during monitoring cycles may be continuously displayed on display screen 32 when accessed through third button 38, allowing the users to evaluate temperature stability and identify potential issues with cooling performance or environmental exposure.

In one embodiment, portable insulin cooler case 10 may incorporate a child lock feature or safety mode that prevents unauthorized modification of alarm thresholds, temperature settings, or other operational parameters configured by primary users or caregivers. The child lock functionality may be implemented through a combination lock sequence requiring users to press first button 34, second button 36, and third button 38 in a specific temporal pattern or order that must be entered before second button 36 enables access to alarm threshold modification functions. Alternatively, the safety mode may utilize a password protection system wherein users must enter a numeric code through sequential button presses before gaining access to parameter modification capabilities, with the password stored in memory module 106 and verified by microcontroller 104 before enabling configuration access. The child lock feature provides particular benefit for pediatric diabetes patients who may inadvertently modify alarm settings during device handling, or for users with cognitive impairments who may unintentionally alter temperature thresholds in ways that compromise insulin storage safety. When child lock mode is activated, first button 34, second button 36, and third button 38 continue to provide display activation and temperature reading functions, but modification of alarm thresholds, High/Low temperature history reset, or other configuration changes remain locked until proper authentication is provided. Display screen 32 may indicate when child lock mode is active through a lock icon or other visual indicator that informs users that configuration functions are currently restricted. The child lock feature may be toggled on or off through a dedicated unlock sequence, allowing primary users or caregivers to enable protection during travel or unsupervised use periods while maintaining full device functionality when supervision is available.

In another embodiment, portable insulin cooler case 10 may include a tamper detection system that monitors and records opening events, providing security functionality particularly valuable during air travel, storage in shared facilities, or use in institutional settings where multiple individuals may have physical access to the device. The tamper detection system may incorporate a magnetic proximity sensor or mechanical switch positioned at the junction between front cover 12 and rear cover 14, configured to detect when closure mechanism 24 is opened and the two covers are separated beyond a threshold distance indicating intentional access to the internal storage area. Each opening event triggers microcontroller 104 to record a timestamp in memory module 106 along with temperature data at the time of opening, creating a complete access log that documents when portable insulin cooler case 10 was opened, how long it remained open, and what temperature conditions existed during the access period. The tamper detection system may distinguish between brief inadvertent openings and sustained access periods that indicate deliberate interaction with stored insulin supplies, filtering transient separation events that may occur during transport vibration or handling while capturing genuine access occurrences. When tamper detection identifies an opening event, microcontroller 104 may generate an access notification transmitted via transceiver 126 to connected mobile devices, alerting primary users or caregivers that portable insulin cooler case 10 has been opened and providing real-time awareness of access occurrences even when users are not physically present. The access log stored in memory module 106 may be reviewed through third button 38, allowing users to examine opening history and verify that insulin supplies have not been subjected to unauthorized access or temperature excursions resulting from improper handling by others. In institutional settings such as schools, workplaces, or medical facilities where insulin storage devices may be kept in shared refrigerators or common storage areas, the tamper detection system provides accountability and documentation that insulin storage integrity has been maintained throughout custody transitions or periods when the device is outside the primary user's direct control.

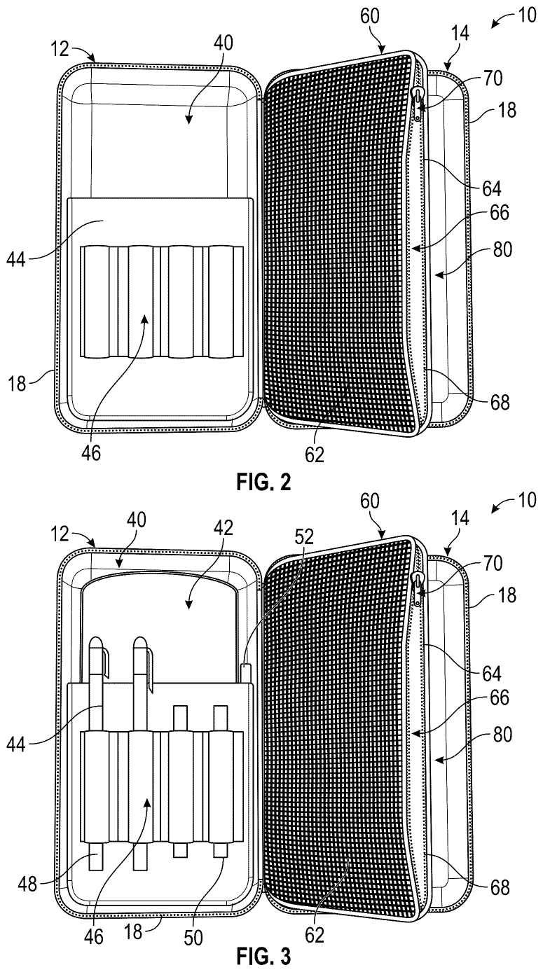

Referring to FIG. 2, portable insulin cooler case 10 includes internal storage components configured to accommodate insulin storage requirements and temperature control elements. Front cover 12 includes a first indented section 40 formed within the recessed cavity of front cover 12. First indented section 40 provides a recessed area that creates internal volume for housing cooling devices and temperature monitoring equipment while maintaining the compact external profile of portable insulin cooler case 10. First indented section 40 is lined with an insulating material that enhances thermal retention properties and helps maintain stable temperature conditions within portable insulin cooler case 10. The insulating material lining may include foam insulation, reflective barriers, or other thermal insulation materials that reduce heat transfer between the internal storage area and external environment.

First indented section 40 of front cover 12 is configured to receive a cooling device 42 that provides temperature regulation for items stored within portable insulin cooler case 10. Referring to FIG. 3, portable insulin cooler case 10 is shown in an open configuration that reveals the internal components and storage arrangement for insulin and temperature control elements. Cooling device 42 indicates a cooler ice bag configured for storing ice to keep things cool and maintain the internal temperature within safe ranges for insulin storage. Cooling device 42 is positioned within first indented section 40 to provide direct thermal contact with the internal storage area while being secured by the structural configuration of front cover 12.

First indented section 40 accommodates a holding sleeve 44 positioned within the recessed area of front cover 12. Holding sleeve 44 is made of water resistant material that protects against moisture exposure and provides durability during regular use and cleaning. Holding sleeve 44 may be constructed from materials such as vinyl, coated fabric, or synthetic materials that resist water penetration while maintaining flexibility for accommodating various insulin storage configurations.

Cooling device 42 is secured within first indented section 40 through the structural arrangement of holding sleeve 44, which provides a retention mechanism that maintains the position of cooling device 42 during transport and use. The cooler ice bag configuration of cooling device 42 allows users to add ice or frozen gel packs that provide sustained cooling capacity for extended periods away from traditional refrigeration sources. The cooling device 42 works in conjunction with the insulating material lining first indented section 40 to create a controlled temperature environment suitable for insulin storage requirements.

Holding sleeve 44 includes a series of elastic bands 46 attached to the surface of holding sleeve 44. Elastic bands 46 are strategically positioned within first indented section 40 in a parallel arrangement that extends across the width of holding sleeve 44, creating multiple retention zones for accommodating different sizes of insulin storage items. The elastic bands 46 are secured to holding sleeve 44 through stitching, adhesive bonding, or mechanical attachment points positioned at regular intervals along the perimeter edges of holding sleeve 44. Each elastic band 46 is tensioned to provide sufficient retention force while maintaining flexibility for easy insertion and removal of insulin items. The spacing between adjacent elastic bands 46 is configured to accommodate the diameter of standard insulin injection pens 48 and insulin containers 50 to provide secure retention without excessive compression. Elastic bands 46 provide retention mechanisms for securing insulin injection pens or insulin containers within portable insulin cooler case 10. The elastic bands 46 are positioned to hold insulin items securely during transport while allowing convenient access and removal when insulin administration is needed. Elastic bands 46 are arranged to secure one or more insulin injection pens 48 or insulin containers 50 within portable insulin cooler case 10, as shown in FIG. 3, for example. The positioning of elastic bands 46 within first indented section 40 ensures that insulin injection pens 48 and insulin containers 50 remain in close proximity to cooling device 42 for optimal temperature control while being held securely by elastic bands 46. Insulin injection pens 48 represent pre-filled insulin delivery devices commonly used by diabetic patients for convenient insulin administration. Insulin containers 50 represent vials, cartridges, or other insulin storage vessels that contain insulin formulations for therapeutic use. Elastic bands 46 provide a retention mechanism that holds insulin injection pens 48 and insulin containers 50 in place during transport while allowing easy access and removal when insulin administration is needed. Elastic bands 46 are positioned to accommodate various sizes and configurations of insulin injection pens 48 and insulin containers 50, providing secure retention without applying excessive pressure that could damage the insulin delivery devices or containers.

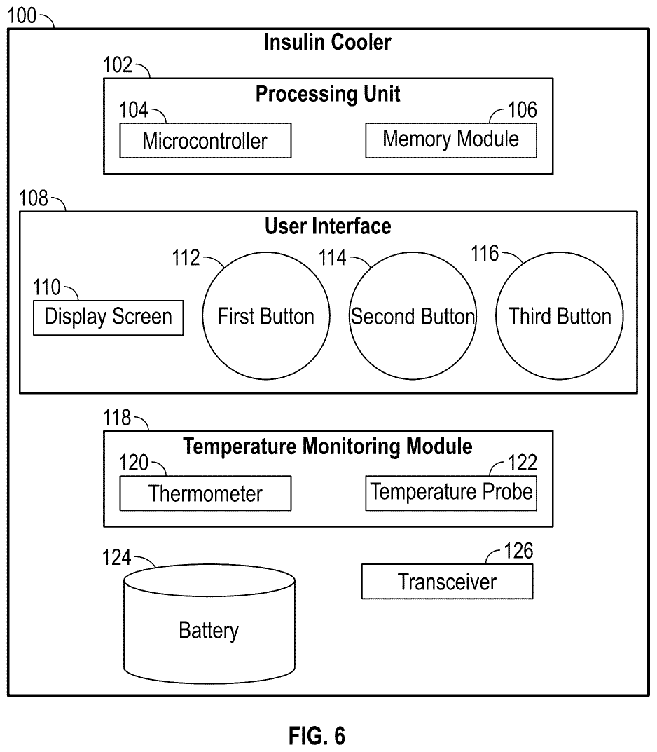

FIG. 3 further shows a thermometer 52 positioned within first indented section 40 to monitor the internal temperature of portable insulin cooler case 10. Thermometer 52 includes temperature sensing capabilities that provide accurate measurement of the thermal conditions within the insulin storage area. A temperature probe of thermometer 52 extends through the insulating material lining first indented section 40 and into the internal area of first indented section 40 to provide direct temperature measurement of the environment where insulin injection pens 48 and insulin containers 50 are stored. The temperature probe configuration allows thermometer 52 to sense temperature variations within the internal storage area while the main body of thermometer 52 remains protected within the structure of first indented section 40. Thermometer 52 communicates temperature data to display screen 32 positioned within housing 30, enabling users to monitor temperature conditions and receive alerts when temperature thresholds are approached or exceeded. Temperature probe 122 (shown in FIG. 6) extends from thermometer 52 on a flexible wire or cable configuration that enables the probe to be threaded through elastic bands 46 and positioned in direct contact with insulin injection pens 48 or insulin containers 50. The flexible probe configuration allows temperature probe 122 to be secured within the elastic band arrangement alongside the insulin storage items, ensuring that temperature measurements are taken at the actual location of the insulin rather than merely sensing ambient air temperature within first indented section 40. This direct-contact temperature sensing configuration eliminates measurement errors that might occur from temperature gradients within the case interior, providing more accurate assessment of the actual thermal conditions experienced by the stored insulin. The flexible probe remains fixed in position relative to the insulin items throughout transport and use, preventing measurement drift that could occur if the probe were loosely positioned within the case interior.

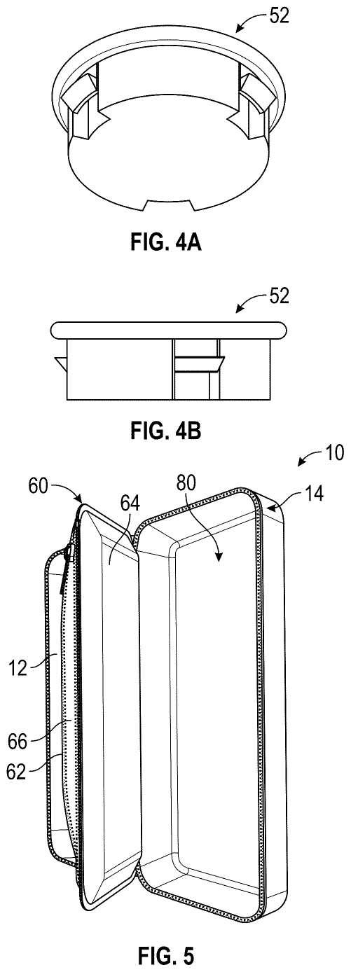

FIG. 4A and FIG. 4B show a bottom perspective view, and a side view, respectively of thermometer 52, in accordance with one exemplary embodiment of the present invention. Thermometer 52 has a cylindrical body configuration with a rounded top surface and a flat bottom surface. The compact form factor allows thermometer 52 to fit within first indented section 40 of front cover 12 without significantly reducing the available storage space for insulin injection pens 48 and insulin containers 50. The compact dimensions of thermometer 52 enable integration within the limited internal volume of portable insulin cooler case 10 while providing temperature monitoring capabilities that are positioned in close proximity to the insulin storage area for accurate temperature measurement.

In one implementation, thermometer 52 may utilize color-coded numerical displays to provide immediate visual feedback regarding temperature status for different seasonal conditions. The color-coding system adapts to seasonal usage patterns to provide appropriate warnings for both overheating and freezing risks that may affect insulin storage.

During summer use conditions, thermometer 52 may implement a color-coding scheme designed to prevent overheating of insulin stored within portable insulin cooler case 10. In this configuration, thermometer 52 displays temperature readings in BLUE coloration to indicate safe temperature conditions where insulin remains adequately cooled within acceptable storage parameters. When temperature conditions begin approaching potentially dangerous heat levels, thermometer 52 transitions to ORANGE coloration to provide warning indication that corrective action may be needed to prevent insulin degradation due to excessive heat exposure. If internal temperatures reach levels that may compromise insulin effectiveness, thermometer 52 displays temperature readings in RED coloration to alert users that conditions have become too hot and that insulin stored within portable insulin cooler case 10 should not be used until proper temperature conditions are restored.

During winter use conditions, thermometer 52 may implement an alternative color-coding scheme designed to prevent freezing of insulin stored within portable insulin cooler case 10. In this seasonal configuration, thermometer 52 displays temperature readings in RED coloration to indicate safe temperature conditions where insulin remains adequately warm and protected from freezing. When temperature conditions begin approaching potentially dangerous cold levels, thermometer 52 transitions to ORANGE coloration to provide warning indication that corrective action may be needed to prevent insulin degradation due to freezing exposure. If internal temperatures reach levels that may cause insulin to freeze, thermometer 52 displays temperature readings in BLUE coloration to alert users that conditions have become too cold and that insulin stored within portable insulin cooler case 10 should not be used until proper temperature conditions are restored.

When thermometer 52 enters the ORANGE warning zone, the device may activate enhanced alert functionality to increase user awareness of approaching temperature dangers. In some aspects, thermometer 52 may generate audible beep signals at each degree crossing within the ORANGE temperature range, providing continuous feedback as temperature conditions change toward potentially unsafe levels. The audible alert system enables users to monitor temperature progression even when display screen 32 is not in direct view, facilitating prompt response to temperature variations that may affect insulin storage safety.

The color-coded temperature indication system of thermometer 52 implements a mathematically centered warning zone logic wherein the Orange warning zone is positioned at a temperature range centered around the user-configured alarm threshold temperature. This centered positioning ensures that users receive adequate intervention time between the initial Orange warning indication and the subsequent Red danger indication (in summer/hot conditions) or Blue freezing indication (in winter/cold conditions). The symmetrical placement of the Orange warning zone around the alarm threshold provides balanced advance warning regardless of whether temperature conditions are trending toward overheating or freezing, enabling timely corrective action before insulin degradation occurs. This centered warning logic matches real-world usage patterns and provides intuitive temperature status feedback that aligns with user expectations for progressive alert escalation.

During ORANGE zone temperature conditions, thermometer 52 may extend the display duration of temperature readings to provide increased visibility of warning conditions. In some cases, temperature numbers may remain displayed on display screen 32 for approximately 30 seconds when ORANGE warning conditions are detected, compared to standard display durations of approximately 10 seconds during normal temperature monitoring. The extended display duration ensures that users have adequate time to observe and respond to warning temperature conditions, reducing the likelihood that temperature alerts may be missed during monitoring periods when insulin storage conditions require immediate attention.

As further shown in FIG. 2, portable insulin cooler case 10 includes a pocket 60 formed between front cover 12 and rear cover 14. Pocket 60 provides additional storage capacity for diabetic accessories and supplies while maintaining the compact design of portable insulin cooler case 10. In one example, pocket 60 may be used to store insulin injection pens 48 or insulin containers 50. Pocket 60 includes a first layer 62 and a second layer 64 that define the internal storage space of pocket 60. First layer 62 is made using a mesh or netting material that provides visibility of stored items while allowing air circulation within pocket 60. The mesh or netting material construction of first layer 62 enables users to quickly identify stored items without opening pocket 60, facilitating efficient access to diabetic supplies during daily use.

Second layer 64 is made using an insulating fabric or material that provides structural support and protection for items stored within pocket 60. The insulating material construction of second layer 64 creates a durable backing that maintains the shape and integrity of pocket 60 during use and transport while providing thermal buffering that prevents excessive cold transfer from cooling device 42 to items stored in pocket 60. The combination of first layer 62 and second layer 64 creates a storage configuration that balances visibility, accessibility, and protection for diabetic accessories stored within portable insulin cooler case 10.

Pocket 60 may accommodate various diabetic accessories that support comprehensive diabetes management and insulin administration. In some aspects, diabetic accessories stored within pocket 60 may include additional insulin injection pens 48 beyond those secured by elastic bands 46, providing backup insulin supplies for extended travel or emergency situations. Insulin containers 50 such as spare insulin vials, cartridges, or refill supplies may be stored within pocket 60 to ensure continuous availability of insulin formulations during periods when primary supplies may be depleted or compromised.

In some cases, pocket 60 may store pen needles of various gauge sizes and lengths to accommodate different injection preferences and anatomical requirements for insulin administration. Alcohol swabs or antiseptic wipes may be positioned within pocket 60 to provide sterile preparation of injection sites, maintaining proper hygiene protocols during insulin administration procedures. Blood glucose testing supplies such as glucose test strips, lancets, or backup glucose meters may be accommodated within pocket 60 to enable comprehensive blood sugar monitoring alongside insulin storage and administration.

Pocket 60 may house additional diabetes medications that complement insulin therapy, such as glucagon emergency kits for treating severe hypoglycemic episodes, or oral diabetes medications that may be prescribed in conjunction with insulin treatment regimens. In some aspects, diabetic accessories may include glucose tablets or gel packets for treating mild hypoglycemic conditions, providing immediate access to fast-acting carbohydrates when blood sugar levels drop below safe ranges.

The storage capacity of pocket 60 may accommodate insulin pen caps, needle disposal containers, or sharps disposal systems that support safe handling and disposal of used injection materials. In some cases, pocket 60 may store backup batteries for glucose meters or other electronic diabetes management devices, ensuring continuous operation of monitoring equipment during extended periods away from charging sources.

Pocket 60 includes a pocket opening 66 defined by first layer 62 and second layer 64. Access to pocket opening 66 is controlled by pocket zipper teeth 68 and a pocket slider 70 that allow pocket opening 66 to be opened or closed as needed. Pocket zipper teeth 68 are positioned around pocket opening 66 i.e., at the edges of first layer 62 and second layer 64 to provide secure closure while maintaining easy access to stored items. Pocket slider 70 engages with pocket zipper teeth 68 and is manipulated to open or close pocket opening 66 for accessing diabetic accessories stored within pocket 60.

With continued reference to FIG. 2, rear cover 14 includes a second indented section 80 configured within the recessed cavity of rear cover 14. Further, FIG. 5 shows rear cover 14 including second indented section 80 configured within the recessed cavity of rear cover 14. Second indented section 80 provides a recessed area that creates internal volume for accommodating additional cooling devices or storage components within the structure of rear cover 14. The positioning of second indented section 80 within rear cover 14 creates a balanced thermal distribution system that works in conjunction with first indented section 40 of front cover 12 to maintain consistent temperature conditions throughout portable insulin cooler case 10. Second indented section 80 may accommodate cooling elements that provide supplementary temperature regulation capacity, extending the overall cooling duration and enhancing the thermal stability of the insulin storage environment. In one example, second indented section 80 is configured to hold additional cooling device that supplements the temperature control capabilities of portable insulin cooler case 10. Second indented section 80 provides additional cooling capacity that extends the duration of temperature control and provides redundant cooling capability to enhance the reliability of insulin storage during extended periods away from traditional refrigeration. Second indented section 80 accommodates cooling devices such as gel packs, ice packs, or other thermal regulation devices that work in conjunction with cooling elements positioned within first indented section 40 to maintain stable temperature conditions throughout portable insulin cooler case 10.

Portable insulin cooler case 10 may be configured in various form factors to accommodate different user preferences and application requirements. The size and shape of front cover 12 and rear cover 14 should not be taken in a limited sense, as a person skilled in the art understands that the shapes provided herein are exemplary and may come in any shape and size without departing from the scope of the present invention. In some aspects, portable insulin cooler case 10 may be configured as a compact rectangular case suitable for pocket carry, while in other implementations, the device may be designed as a larger cylindrical container for extended travel applications. The form factor may include variations such as a slim profile case that fits within a briefcase or purse, a belt-mounted configuration for hands-free carrying, or a larger capacity design for storing multiple insulin supplies and diabetic accessories.

The structural configuration of front cover 12 and rear cover 14 may be adapted to various geometric shapes including oval, circular, square, or irregular contours that optimize internal volume while maintaining portability. In some cases, the covers may incorporate ergonomic features such as curved surfaces or textured grips that enhance user comfort during handling and transport. The overall dimensions of portable insulin cooler case 10 may range from compact personal-sized units measuring approximately 4 inches by 6 inches to larger family-sized configurations that accommodate multiple users' insulin storage requirements.

Portable insulin cooler case 10 may be utilized as a travel accessory or portable temperature-controlled storage device depending on the specific needs and regulatory requirements of the application. When configured as a travel accessory, portable insulin cooler case 10 provides convenient insulin storage and temperature monitoring capabilities for recreational travel, business trips, or daily commuting activities. In portable temperature-controlled storage device applications, portable insulin cooler case 10 may incorporate additional features such as enhanced temperature logging, medical-grade materials, or compliance with specific regulatory standards for medical equipment. The versatility of the design allows portable insulin cooler case 10 to serve both consumer and medical markets while maintaining the core functionality of temperature-controlled insulin storage and monitoring.

FIG. 6 shows a block diagram of an insulin cooler or portable insulin storage system 100, in accordance with one exemplary embodiment of the present invention. Insulin cooler 100 represents the same device as portable insulin cooler case 10 described above, with insulin cooler 100 illustrating the electronic system architecture and functional components that enable the temperature monitoring and control capabilities of the device. The block diagram representation of insulin cooler 100 in FIG. 6 provides a detailed view of the internal electronic components, processing systems, and communication interfaces that operate within the physical structure of portable insulin cooler case 10 shown in the preceding figures. The electronic components depicted in insulin cooler 100 are integrated within housing 30, thermometer 52, and/or other structural elements of portable insulin cooler case 10 to provide the temperature monitoring, user interface, and alarm functionality described throughout this disclosure. The terminology insulin cooler 100 and portable insulin cooler case 10 may be used interchangeably when referring to the complete system that combines the physical enclosure, thermal management components, and electronic control systems into a unified portable device for insulin storage and temperature monitoring.

Insulin cooler 100 includes a processing unit 102 that manages the overall operation and coordination of electronic components within insulin cooler 100. Processing unit 102 includes a microcontroller 104 and a memory module 106 that work together to control the functions of insulin cooler 100. Microcontroller 104 manages the overall operation of insulin cooler 100, coordinating the functions of various electronic components and processing temperature data received from monitoring systems. Microcontroller 104 may include programmable logic circuits, input/output interfaces, and timing control systems that enable real-time monitoring and response to temperature conditions within the insulin storage environment.

Memory module 106 stores data and program instructions for microcontroller 104, providing storage capacity for temperature history, user settings, and operational parameters. memory module 106 may include volatile memory such as random access memory (RAM) for temporary data storage during operation and non-volatile memory such as flash memory or electrically erasable programmable read-only memory (EEPROM) for permanent storage of configuration settings and temperature history data. Memory module 106 enables insulin cooler 100 to retain user preferences, alarm thresholds, and historical temperature records even when power is removed from the system.

Insulin cooler 100 further includes a user interface 108 that provides interaction capabilities between users and the electronic control system. User interface 108 comprises a display screen 110, a first button 112, a second button 114, and a third button 116 that enable users to monitor temperature conditions and configure operational settings. First button 112, second button 114, and third button 116 are implemented as touch-sensitive switches that respond to user contact without requiring mechanical actuation, providing reliable user input while eliminating moving parts that might wear or fail during extended use. Display screen 110 provides visual feedback to users, displaying temperature information and status indicators in a format that allows users to quickly assess the thermal conditions within insulin cooler 100. Display screen 110 may include digital display technology that presents temperature readings in degrees Fahrenheit or degrees Celsius, along with color-coded indicators that communicate temperature status through visual cues. Display screen 110 includes intelligent activation features that optimize battery consumption. Display screen 110 activates automatically when users contact any button or when temperature measurements cross whole degree thresholds, displaying information for approximately 10 seconds before returning to an inactive state. During orange warning conditions, display screen 110 extends activation to approximately 30 seconds. When alarm conditions are triggered, display screen 110 activates in flashing mode for approximately 1 minute. Display screen 110 remains inactive during normal monitoring periods to extend battery life while maintaining continuous temperature monitoring.

First button 112 functions as an ON/OFF control for powering insulin cooler 100 and controlling the activation of electronic components within insulin cooler 100. First button 112 allows users to manage power consumption by enabling or disabling the monitoring and display functions when insulin cooler 100 is not in active use. Second button 114 serves as an alarm control that enables users to set temperature alerts and configure notification settings for temperature threshold monitoring. Second button 114 allows users to establish temperature limits that trigger audible or visual alarms when the internal temperature of insulin cooler 100 approaches or exceeds safe storage ranges for insulin. Third button 116 operates as a High/Low temperature recording control that provides access to temperature history data collected during monitoring cycles. Third button 116 enables the users to view the highest and lowest temperatures recorded during specified time periods, providing valuable information for assessing the thermal performance of insulin cooler 100 under various environmental conditions.

As further shown in FIG. 6, insulin cooler 100 includes a temperature monitoring module 118 that provides temperature sensing and measurement capabilities for the insulin storage environment. Temperature monitoring module 118 includes a thermometer 120 and a temperature probe 122 that work together to measure and report temperature conditions within insulin cooler 100. Thermometer 120 measures the internal temperature of insulin cooler 100 and converts temperature readings into electrical signals that may be processed by processing unit 102. Temperature probe 122 extends from thermometer 120 to sense the temperature within the internal area of insulin cooler 100, providing direct contact with the environment where insulin is stored and enabling real-time assessment of insulin storage conditions. Temperature probe 122 may include temperature-sensitive elements such as thermistors, resistance temperature detectors (RTDs), or thermocouple sensors that provide accurate temperature measurement across the operating temperature range required for insulin storage.

Temperature monitoring module 118 communicates temperature data to processing unit 102 through electrical connections that enable real-time monitoring and processing of temperature information for continuous assessment of insulin storage conditions. Processing unit 102 processes temperature data received from temperature monitoring module 118 and controls display screen 110 to present temperature status information to users. The electrical connection between thermometer 120 and display screen 110 enables continuous temperature monitoring and immediate visual feedback when temperature conditions change within insulin cooler 100. This electrical connection allows display screen 110 to display current temperature readings, historical temperature data, and alarm notifications based on temperature thresholds established by users through the user interface 108.

Insulin cooler 100 further includes a battery 124 that provides electrical power to the electronic components within insulin cooler 100. Battery 124 supplies power to processing unit 102, user interface 108, temperature monitoring module 118, and other electronic components that enable the monitoring and control functions of insulin cooler 100. Battery 124 may include rechargeable battery technology such as lithium-ion batteries that provide extended operating time while maintaining compact dimensions suitable for portable applications. Battery 124 enables insulin cooler 100 to operate independently of external power sources during transport and daily use, providing continuous temperature monitoring capabilities even when users are away from electrical power outlets.

In one embodiment, insulin cooler 100 may incorporate supplementary power generation capabilities through a solar charging module or kinetic energy harvesting system that augments battery 124 capacity and extends operational duration during remote or outdoor use where traditional charging infrastructure is unavailable. The solar charging module may include one or more photovoltaic cells integrated into the exterior surface of front cover 12 or rear cover 14, positioned to receive ambient light exposure during normal carrying and storage orientations. The photovoltaic cells convert incident light energy into electrical current that charges battery 124 through a charge management circuit within processing unit 102, providing continuous trickle charging that offsets the power consumption of temperature monitoring module 118, display screen 110, and other electronic components. The solar charging configuration enables insulin cooler 100 to maintain operational capability during extended outdoor activities such as camping, hiking, or remote travel where battery replacement or conventional charging may be impractical. Alternatively, insulin cooler 100 may incorporate a kinetic energy harvesting system comprising an electromagnetic induction generator or piezoelectric element that converts mechanical motion experienced during normal carrying and transport into electrical energy. The kinetic energy harvesting system captures vibrational energy from walking, vehicle transport, or routine device handling, converting this ambient mechanical energy into electrical current that charges battery 124. The kinetic charging configuration provides passive power generation that accumulates during normal use patterns without requiring deliberate user action or specific environmental conditions. In some embodiments, insulin cooler 100 may incorporate both solar and kinetic charging systems operating in parallel, enabling power generation from multiple sources to maximize charging capability across diverse usage scenarios and environmental conditions. The supplementary power generation extends the operational life of battery 124, reduces the frequency of battery replacement requirements, and provides enhanced reliability for users who depend on insulin cooler 100 during extended periods in remote locations where battery failure could create life-threatening insulin storage failures.

As further shown in FIG. 6, insulin cooler 100 includes a transceiver 126 that enables wireless communication capabilities for connecting insulin cooler 100 to external devices and communication networks. Transceiver 126 enables wireless communication capabilities, allowing insulin cooler 100 to transmit temperature data and status information to external devices such as mobile phones or other computing devices. Transceiver 126 may include Bluetooth, Wi-Fi, or other wireless communication protocols that enable data transmission between insulin cooler 100 and user devices within communication range.

In one implementation, insulin cooler 100 includes a mobile connectivity application that allows connection to a user's mobile device for temperature updates. The mobile connectivity application works in conjunction with transceiver 126 to establish communication links between insulin cooler 100 and mobile devices such as smartphones or tablets. The mobile connectivity application enables users to receive temperature updates, alarm notifications, and historical temperature data on their mobile devices, providing remote monitoring capabilities when insulin cooler 100 is not in direct visual range. The mobile connectivity application may provide features such as temperature trend analysis, customizable alert settings, and data logging capabilities that enhance the overall functionality of insulin cooler 100 for diabetes management applications. Users may receive real-time temperature notifications on their mobile devices when temperature conditions within insulin cooler 100 approach or exceed safe storage ranges, enabling prompt corrective action to protect insulin from temperature-related degradation.

In one embodiment, the mobile connectivity application may incorporate an alert escalation system that automatically notifies designated caregivers, family members, or medical personnel when temperature alarms generated by insulin cooler 100 are not acknowledged by the primary user within a specified time period. The alert escalation functionality addresses scenarios where users may be sleeping, incapacitated, distracted, or otherwise unable to respond to temperature warnings, ensuring that critical temperature deviations receive timely attention even when the primary user cannot take immediate corrective action. When microcontroller 104 activates an alarm condition based on temperature thresholds being exceeded, transceiver 126 transmits the alarm notification to the primary user's mobile device through the mobile connectivity application. If the mobile application does not receive an acknowledgment response from the primary user within a predetermined timeout period, such as 5 minutes, 10 minutes, or another user-configurable interval stored in memory module 106, the escalation system automatically transmits secondary alert notifications to caregiver contact information stored in the mobile application. The secondary alerts may be sent via multiple communication channels including push notifications to caregiver mobile devices, SMS text messages, email notifications, or automated telephone calls, ensuring that caregivers receive alarm information through communication methods most likely to produce rapid response. The caregiver alert escalation provides particular benefit for pediatric diabetes patients whose parents or guardians require awareness of insulin storage issues, elderly users whose family members monitor their diabetes management, or individuals with cognitive impairments whose caregivers maintain oversight of medication storage safety. Each escalated alert transmitted to caregivers includes current temperature information, timestamp of the alarm condition, duration of the unacknowledged alarm, and last known location of insulin cooler 100 if geolocation features are enabled, providing caregivers with complete situational awareness needed to assess the severity of the storage incident and coordinate appropriate response measures.

In another embodiment, insulin cooler 100 may incorporate a medication adherence support system that generates scheduled reminders prompting users to administer insulin doses according to prescribed treatment regimens, with confirmation tracking functionality that monitors whether users acknowledge dosing prompts and provides adherence data for clinical review. The adherence support system operates through the mobile connectivity application working in conjunction with microcontroller 104 and memory module 106, which stores a dosing schedule configured by users or healthcare providers specifying insulin administration times throughout the day. At scheduled dosing times, microcontroller 104 generates reminder notifications transmitted via transceiver 126 to the mobile application, which displays visual alerts and produces audible or vibrational notifications prompting users to check blood glucose levels and administer insulin as prescribed. The mobile application provides a confirmation interface allowing users to acknowledge each dosing prompt, recording the acknowledgment timestamp in memory module 106 to document medication administration events. When users do not acknowledge dosing prompts within a specified time window, the adherence support system may generate follow-up reminders at escalating intervals, ensuring that missed doses receive attention before therapeutic timing windows close. The adherence tracking data accumulated in memory module 106 creates a comprehensive medication adherence record documenting patterns of on-time administration, delayed doses, and missed doses over extended monitoring periods. This adherence data may be reviewed by users through the mobile application to assess their own medication compliance patterns, or exported for clinical review by healthcare providers during diabetes management consultations. The adherence support system may incorporate intelligent scheduling algorithms that adjust reminder timing based on historical user response patterns, meal schedules, activity levels, or other contextual factors that influence optimal insulin administration timing. For users who maintain consistent adherence patterns, the system may reduce reminder frequency to minimize notification fatigue, while users who demonstrate irregular adherence patterns may receive more frequent prompts and escalated follow-up reminders to support improved medication compliance. The integration of adherence support functionality with the temperature-controlled storage capabilities of insulin cooler 100 creates a comprehensive insulin management system that addresses both proper medication storage and consistent administration timing, supporting improved diabetes control through multifaceted behavioral support.

Referring to FIG. 6, the operational interaction of components within insulin cooler 100 is explained. The operational flow begins with temperature monitoring module 118, where temperature probe 122 continuously senses the ambient temperature within the internal storage area of insulin cooler 100. Temperature probe 122 converts thermal energy into electrical signals that represent the current temperature conditions, providing real-time data about the thermal environment where insulin injection pens and insulin containers are stored.

Thermometer 120 receives the electrical signals from temperature probe 122 and processes the electrical signals to generate digital temperature data that may be transmitted to processing unit 102. The temperature measurement process occurs continuously during operation, providing ongoing assessment of thermal conditions within insulin cooler 100. Processing unit 102 receives temperature data from thermometer 120 through electrical connections that enable data transfer between temperature monitoring module 118 and the central control system.

Microcontroller 104 within processing unit 102 processes the incoming temperature data and compares the measured temperature values against predetermined threshold settings stored in memory module 106. Memory module 106 contains user-configured temperature limits, alarm settings, and historical temperature records that enable microcontroller 104 to evaluate whether current temperature conditions fall within acceptable ranges for insulin storage. When temperature measurements indicate that conditions remain within safe storage parameters, microcontroller 104 continues normal monitoring operations and updates display screen 110 with current temperature information.

Display screen 110 receives processed temperature data from processing unit 102 and presents temperature information to users through visual displays that may include numerical temperature readings and color-coded status indicators. The visual presentation enables the users to quickly assess temperature conditions and determine whether insulin storage conditions remain within acceptable parameters. Display screen 110 may present temperature information in degrees Fahrenheit or degrees Celsius based on user preferences stored in memory module 106.

The intelligent activation of display screen 110 provides a critical user notification feature that enables detection of temperature changes without requiring constant monitoring. By flashing or illuminating at each whole-degree transition, display screen 110 captures user attention through peripheral vision, allowing users to remain aware of temperature status even when engaged in other activities such as medical procedures, work tasks, or travel activities. In some aspects, display screen 110 may include intelligent activation features that optimize battery consumption while maintaining effective temperature monitoring capabilities. Display screen 110 may activate automatically when temperature measurements cross from one whole number temperature range to another whole number temperature range, providing users with updates at temperature transitions that may be significant for insulin storage assessment. For example, when the internal temperature changes from 35.7° F. to 36.2° F., display screen 110 activates because the temperature measurement has crossed into the 36° range, indicating a potentially significant temperature change that users may need to evaluate. Similarly, when temperature conditions change from 78.9° F. to 79.1° F., display screen 110 activates as the temperature measurement has crossed into the 79° range, providing notification of the temperature transition. However, when temperature fluctuations occur within the same whole number range, such as temperature changes from 37.5° F. to 37.9° F., display screen 110 may remain inactive since no crossing between whole number temperature ranges has occurred. This intelligent activation approach enables users to receive updates at temperature changes that may be important for insulin storage evaluation without constant display activation that may drain battery 124 unnecessarily, thereby extending the operational duration of insulin cooler 100 while maintaining effective temperature monitoring capabilities.

When temperature measurements exceed predetermined threshold values stored in memory module 106, microcontroller 104 initiates alarm functions that provide immediate notification to users about potentially unsafe temperature conditions. The alarm activation process includes generating visual alerts on display screen 110 and may include audible alarm signals that continue until users acknowledge the alarm condition or temperature conditions return to acceptable ranges. The alarm provides early warning capabilities that enable the users to take corrective action before insulin stored within insulin cooler 100 experiences temperature-related degradation.

User interaction with insulin cooler 100 occurs through user interface 108, where first button 112, second button 114, and third button 116 provide control functions for insulin cooler 100 operation. The users may activate first button 112 to power insulin cooler 100 on or off, controlling the operation of electronic components and managing battery consumption during periods when temperature monitoring is not required. Second button 114 enables the users to configure alarm threshold settings by accessing temperature limit parameters stored in memory module 106 and modifying these values based on specific insulin storage requirements or environmental conditions.

Third button 116 provides access to historical temperature data stored in memory module 106, allowing users to review the highest and lowest temperatures recorded during specified monitoring periods. When the users activate third button 116, microcontroller 104 retrieves temperature history data from memory module 106 and presents the information on display screen 110, enabling the users to assess the thermal performance of insulin cooler 100 over time and identify potential issues with temperature control or environmental exposure.

Transceiver 126 enables wireless communication between insulin cooler 100 and external devices, allowing temperature data and alarm notifications to be transmitted to mobile devices or other computing systems. When temperature conditions trigger alarm functions, transceiver 126 may transmit alert messages to connected mobile devices, providing remote notification capabilities that enable users to respond to temperature issues even when insulin cooler 100 is not in direct visual range.

Battery 124 provides continuous electrical power to all electronic components within insulin cooler 100, enabling uninterrupted temperature monitoring and alarm functions during transport and daily use. The power management system within microcontroller 104 may include energy conservation features that optimize battery consumption by controlling the activation of display screen 110 and other power-consuming components based on user activity and monitoring requirements. This power management approach extends the operational duration of insulin cooler 100 while maintaining continuous temperature monitoring capabilities that protect insulin from temperature-related degradation.

In an exemplary setup configuration, insulin cooler 100 may be configured with temperature alarm thresholds that accommodate seasonal storage requirements and environmental conditions. During summer storage conditions, users may set the alarm threshold to 79° F. to prevent overheating of insulin stored within insulin cooler 100. The 79° F. threshold provides early warning when ambient temperatures approach levels that may compromise insulin effectiveness, allowing users to take corrective action such as relocating insulin cooler 100 to a cooler environment or activating additional cooling measures.

During winter storage conditions, users may configure the alarm threshold to 36° F. to prevent freezing of insulin stored within insulin cooler 100. The 36° F. threshold alerts users when temperatures approach the lower limit of safe insulin storage ranges, enabling preventive measures to avoid insulin degradation due to freezing conditions. This winter configuration may be particularly beneficial during outdoor activities, cold weather travel, or storage in unheated environments where temperatures may drop below safe insulin storage parameters.

Insulin cooler 100 may include a default alarm setting of 79° F. that provides general-purpose temperature monitoring suitable for typical storage and transport conditions. The default 79° F. setting offers protection against overheating while accommodating normal room temperature variations that occur during daily use and transport activities. Users may modify the default alarm threshold through second button 114 to establish customized temperature limits based on specific environmental conditions, seasonal requirements, or individual insulin storage preferences. The alarm threshold settings are stored in memory module 106 and remain active until users modify the configuration through user interface 108.

The present invention provides several advantages over existing portable insulin cooling systems disclosed in the prior art. The integrated temperature monitoring capabilities of the insulin cooler offer continuous real-time temperature assessment through the temperature monitoring module, which includes the thermometer and temperature probe positioned directly within the insulin storage environment. This configuration provides more accurate and responsive temperature measurement compared to prior art systems that may rely on external temperature sensors or lack comprehensive monitoring capabilities.

The user interface of the insulin cooler provides enhanced user control and feedback through the display screen and multiple button controls including the first button, second button, and third button. This multi-button interface enables users to access various functions such as power control, alarm configuration, and historical temperature data review, providing more comprehensive device management compared to prior art systems that may offer limited user interaction capabilities.

The wireless communication capabilities enabled by the transceiver allow the insulin cooler to transmit temperature data and alarm notifications to external devices such as mobile phones or computing devices. This remote monitoring functionality provides users with temperature updates and alerts even when the insulin cooler is not in direct visual range, offering improved convenience and safety monitoring compared to prior art systems that may lack wireless connectivity features.

The alarm functionality of the insulin cooler provides both visual and audible notifications when temperature conditions approach or exceed safe storage ranges for insulin. Unlike existing portable insulin cooling products currently available in the market, which lack temperature alarm capabilities, the alarm system operates through the microcontroller processing temperature data against user-configured threshold settings stored in the memory module, enabling customizable temperature monitoring that may be adapted to specific insulin storage requirements and individual user preferences. This comprehensive alarm system provides more sophisticated temperature alerting compared to prior art systems that may offer basic indicator lights or limited notification capabilities.

The historical temperature recording capabilities accessible through the third button enable users to review the highest and lowest temperatures recorded during specified monitoring periods. This temperature history functionality allows users to assess the thermal performance of the insulin cooler over time and identify potential issues with temperature control or environmental exposure, providing valuable data for insulin storage management that may not be available in prior art systems.

The power management system within the microcontroller includes energy conservation features that optimize battery consumption by controlling the activation of the display screen and other power-consuming components based on temperature threshold crossings and user activity, thereby extending operational duration while maintaining continuous temperature monitoring capabilities.

The mobile connectivity application that works in conjunction with the transceiver enables users to receive temperature updates, alarm notifications, and historical temperature data on their mobile devices. This mobile integration provides features such as temperature trend analysis, customizable alert settings, and data logging capabilities that enhance the overall functionality of the insulin cooler for diabetes management applications, offering more comprehensive mobile device integration compared to prior art systems that may lack mobile application support.

A person skilled in the art appreciates that the portable insulin cooler case can come in a variety of shapes and sizes depending on the need and comfort of the user. Further, many changes in the design and placement of components may take place without deviating from the scope of the presently disclosed portable insulin cooler case.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A portable insulin cooler case, comprising:
a front cover and a rear cover connected by a hinge to form an enclosure;
a closure mechanism positioned around perimeter edges of said front cover and said rear cover to seal said enclosure;
a housing positioned on said front cover;
a display screen positioned within said housing and configured to display temperature information;
a first button, a second button, and a third button positioned within said housing, wherein said first button functions as an ON/OFF control, said second button serves as an alarm control, and said third button operates as a High/Low temperature recording control;
a first indented section formed within said front cover and configured to receive a cooling device;
a thermometer positioned within said first indented section and configured to monitor internal temperature of said portable insulin cooler case;
elastic bands positioned within said first indented section and configured to secure insulin injection pens or insulin containers; and
a pocket formed between said front cover and said rear cover, wherein said pocket is configured to store diabetic accessories.

2. The portable insulin cooler case of claim 1, wherein said closure mechanism comprises zipper teeth, a slider, and a pull tab.

3. The portable insulin cooler case of claim 2, wherein said zipper teeth extend around said perimeter edges of both said front cover and said rear cover to create a substantially airtight seal.

4. The portable insulin cooler case of claim 1, wherein said display screen displays a first color indicating safe temperature conditions, a second color indicating approaching temperature limits, and a third color indicating temperature limits are exceeded.

5. The portable insulin cooler case of claim 1, wherein said second button allows a user to set temperature thresholds that trigger audible or visual alarms when internal temperature rises above or falls below specified temperature limits.

6. The portable insulin cooler case of claim 1, wherein said third button allows a user to view highest and lowest temperatures reached inside said portable insulin cooler case during a specified recording period.

7. The portable insulin cooler case of claim 1, further comprising a holding sleeve positioned within said first indented section, wherein said elastic bands are attached to a surface of said holding sleeve.

8. The portable insulin cooler case of claim 1, further comprising a second indented section formed within said rear cover and configured to accommodate additional cooling devices.

9. The portable insulin cooler case of claim 1, further comprising a processing unit configured to execute a predictive temperature management algorithm that analyzes at least one of (i) historical temperature data stored in the device memory, (ii) current temperature readings from the internal sensor, and (iii) user behavior patterns such as device openings or activation times, to generate an alert signal when predicted internal temperature is projected to exceed a predefined safety threshold within a specified time period.

10. The portable insulin cooler case of claim 1, further comprising a medication adherence support system configured to generate scheduled alerts prompting insulin dose administration and an acknowledgment interface configured to record user responses, wherein the recorded adherence data are stored in a memory module and retrievable for clinical review.

11. A portable insulin storage system, comprising:
a portable insulin cooler case comprising a front cover and a rear cover connected by a hinge, wherein said portable insulin cooler case comprises a first indented section formed within said front cover and configured to receive a cooling device, wherein said portable insulin cooler case comprises a second indented section formed within said rear cover and configured to accommodate additional cooling devices, wherein said portable insulin cooler case comprises a pocket formed between said front cover and said rear cover, and wherein said pocket is configured to store diabetic accessories;
a thermometer positioned within said first indented section and configured to monitor internal temperature of said portable insulin cooler case and provide temperature data for real-time assessment of insulin storage conditions;
elastic bands positioned within said first indented section and configured to secure insulin injection pens or insulin containers in proximity to said cooling device; and
a processing unit comprising a microcontroller and a memory module, wherein said microcontroller processes temperature data received from said thermometer and controls alarm functions of said portable insulin storage system based on predetermined threshold settings stored in said memory module; and
a user interface comprising a display screen and a plurality of control buttons, wherein said display screen presents temperature information and status indicators received from said processing unit, and wherein said plurality of control buttons enable user configuration of temperature thresholds and access to historical temperature data stored in said memory module.

12. The portable insulin storage system of claim 11, wherein said plurality of control buttons comprises a first button functioning as an ON/OFF control, a second button serving as an alarm control, and a third button operating as a High/Low temperature recording control.

13. The portable insulin storage system of claim 12, wherein said second button allows a user to set temperature thresholds that trigger audible or visual alarms when internal temperature rises above or falls below specified temperature limits.

14. The portable insulin storage system of claim 13, wherein said third button allows a user to view highest and lowest temperatures reached inside said portable insulin storage system during a specified recording period.

15. The portable insulin storage system of claim 11, wherein said display screen provides color-coded indication to communicate temperature status, displaying different colorations based on usage patterns to provide warnings for both overheating and freezing risks.

16. The portable insulin storage system of claim 11, further comprising a transceiver that enables connection to a mobile connectivity application that allows users to receive temperature updates, alarm notifications, and historical temperature data on mobile devices.

17. A method of providing a portable insulin cooler case, the method comprising the steps of:
providing a front cover and a rear cover connected by a hinge to form an enclosure;
providing a closure mechanism positioned around perimeter edges of said front cover and said rear cover to seal said enclosure;
providing a housing positioned on said front cover;
providing a display screen positioned within said housing and configured to display temperature information;
providing a first button, a second button, and a third button positioned within said housing, said first button functioning as an ON/OFF control, said second button serving as an alarm control, and said third button operating as a High/Low temperature recording control;
providing a first indented section formed within said front cover and configured to receive a cooling device;
providing a thermometer positioned within said first indented section and configured to monitor internal temperature of said portable insulin cooler case;
providing elastic bands positioned within said first indented section and configured to secure insulin injection pens or insulin containers; and
providing a pocket formed between said front cover and said rear cover, wherein said pocket is configured to store diabetic accessories.

18. The method of claim 17, wherein said display screen displays a first color indicating safe temperature conditions, a second color indicating approaching temperature limits, and a third color indicating temperature limits are exceeded.

19. The method of claim 18, wherein said thermometer generates audible beep signals when temperature conditions enter said Orange coloration warning zone.

20. The method of claim 17, further comprising providing a transceiver that enables wireless communication for transmitting the temperature monitored.
